(19) United States
(12) Patent Application Publication
(10) Pub. No.: US 2012/0307590 A1
(43) Pub. Date: Dec. 6, 2012

(54) PINSCREEN SENSING DEVICE

(75) Inventor: Jessica Suzanne Faruque, Palo Alto, CA (US)

(73) Assignee: CANON KABUSHIKI KAISHA, Tokyo (JP)

(21) Appl. No.: 13/153,259

(22) Filed: Jun. 3, 2011

(51) Int. Cl. G03B 42/06; G01B 11/02

(52) U.S. Cl. 367/7; 356/496; 73/865.8

(57) ABSTRACT

Systems and methods for sensing one or more signals include a plurality of pins, wherein the pins are independently movable relative to one another, one or more signal generators coupled to respective pins, one or more signal detectors coupled to respective pins, and a body, wherein the plurality of pins are coupled to the body.

### BACKGROUND

1. Field of the Disclosure

The present disclosure relates generally to sensing information about objects.

2. Description of the Related Art

Many forms of surface and subsurface sensing (e.g., imaging) exist, such as acoustic and optical sensing, with applications in medicine, art, geology, and materials science. Generally, these sensing technologies send signals into the medium being imaged and detect signals reflected by the medium, and an image of the medium can be constructed from the detected signals. Examples of sensing devices include Ultrasound imaging devices and Optical Coherence Tomography devices. Different technologies have different abilities to penetrate a surface. For example, Optical Coherence Tomography (also referred to herein as “OCT”) may be limited to a depth of 1 to 2 mm in biological tissue, while Ultrasound imaging can penetrate further.

### SUMMARY

In one embodiment, a device for imaging comprises a frame and a plurality of independently positionable members coupled to the frame, wherein a respective independently positionable member is elongated along a first axis, is positionable relative to the frame, and includes an imaging element.

In one embodiment, a device for sensing one or more signals comprises a plurality of pins, wherein the pins are independently movable relative to one another, one or more signal generators coupled to respective pins, one or more signal detectors coupled to respective pins, and a body, wherein the plurality of pins are coupled to the body.

In one embodiment, a device for imaging comprises a plurality of sensors configured to detect signals, and means for mounting the plurality of sensors such that the plurality of sensors are independently movable.

### BRIEF DESCRIPTION OF THE DRAWINGS

FIG. 1 illustrates an embodiment of a pinscreen sensing device.

FIG. 2 illustrates an embodiment of part of a pinscreen sensing device.

FIGS. 3A and 3B illustrate embodiments of a collar and an aperture.

FIGS. 4A and 4B illustrate embodiments of a frame for a pinscreen sensing device.

FIG. 5 is a block diagram that illustrates an embodiment of a sensing system.

FIG. 6 is a block diagram that illustrates an embodiment of a method for sensing.

### DETAILED DESCRIPTION

The following description is of certain illustrative embodiments, and the disclosure is not limited to these embodiments, but includes alternatives, equivalents, and modifications such as are included within the scope of the claims. Additionally, the illustrative embodiments may include several novel features, and a particular feature may not be essential to practice the systems and methods described herein.

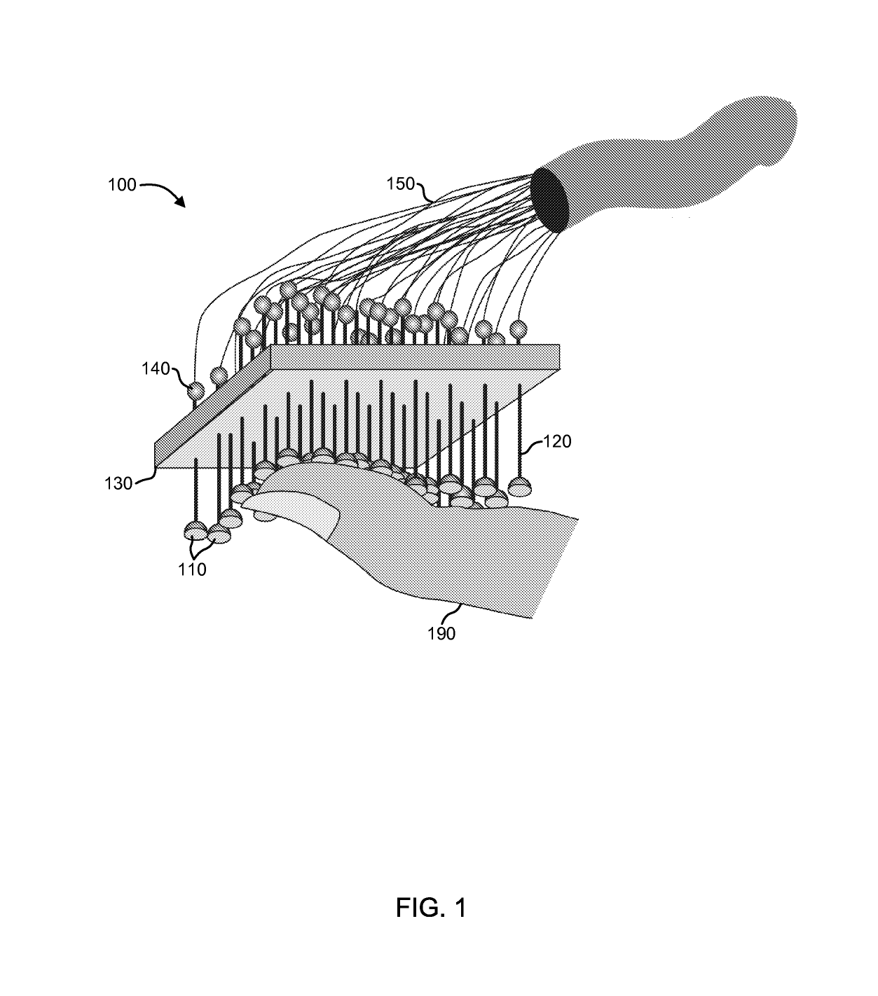

FIG. 1 illustrates an embodiment of a pinscreen sensing device 100. The pinscreen sensing device 100 includes a plurality of sensors 110 each mounted to a proximal end of a respective pin 120. The pins 120 are coupled to a frame 130. The distal ends of the pins 120 each have a respective stopper 140 (which may also include a pin position detector). Signals (which may include sensed data) are sent from the sensors 110 to system and devices, such as a computing device (not shown in FIG. 1). In the embodiment shown, the signals are sent via one or more wires 150.

The pinscreen sensing device 100 illustrated in FIG. 1 is positioned to capture images from an object 190 (which is a human finger in FIG. 1). The pins 120 are positionable relative to the frame 130 (e.g., the pins 120 may slide within the frame 130) and are independently positionable relative to one another. Thus, the pins 120 may move to alter the positions of their respective sensors 110, allowing the sensors 110 to be positioned to conform to the contours of the object 190. Thus, by allowing each sensor 110 to be positioned according to a position of a respective portion of the surface of the object 190, the sensors 110 may be positioned in close proximity to their respective portion of the surface of the object 190. This may allow the sensors 110 to create a configurable sensing surface that conforms to an object, which may improve sensing, for example with sensors that require, or perform better in, close proximity to the object being sensed, and may also reduce the pressure exerted on the object (e.g., the sensors 110 may not need to be pushed into the object to increase a contact area with the object). Also, the positionable pins 120 allow the sensors 110 to be repositioned to sense another object. The sensors may include ultrasound sensors, high-intensity focused ultrasound sensors, optical coherence tomography sensors, electrical impedance tomography sensors, diffusive optical imaging sensors, etc.

The sensors 110 each include a respective receiver, respective transmitter, and/or a respective transducer (e.g., a transceiver that includes both a receiver and transmitter). The sensors 110 may be any size used in the art (for example, sensors sizes include 2 mm×10 mm, 12 mm×16 mm, 32 mm×26 mm, a 2×16 array of ultrasound sensors that has a width of 5 mm, etc.), and the size of the sensor 110 may be selected based on the size and contours of the objects expected to be sensed, desired sensing resolution, and cost, among other factors.

The sensors may include, for example, piezoelectric sensors. Piezoelectric sensors include materials that produce a change in an electric field in response to pressure (i.e., pressure sensitive materials). As a signal transmitter, piezoelectric sensors operate by sending out a physical wave proportional to an electrical signal used to excite the piezoelectric material. As a signal receiver, piezoelectric sensors produce an electric field proportional to a detected change in pressure. Capacitive sensors include capacitors in which one of the plates includes a flexible membrane and which can produce signals. To transmit a signal, a voltage is applied to the capacitor, which produces a variation in the distance between the plates, which generates an outgoing pressure wave. The reverse occurs when detecting a signal: the capacitor membrane vibrates as a result of an incoming pressure wave, and the resulting change in separation between the capacitor plates creates a change in voltage, which may be detected and stored on a computing device.

Also for example, ultrasonic sensors may operate on a frequency in the range of 2-50 MHz, and may have a depth of penetration of 1 mm-10 cm through human tissue for standard clinical applications. OCT sensors may operate on a 2-200 kHz scanning frequency and may have a 0.5-1.25 mm depth of penetration through human tissue. However, different embodiments of sensors may have different specifications.

The pins 120 are members that are elongated along an axis and may be any suitable material, such as metal, plastic, and/or wood. The pins 120 may also be hollow, and, though the pins 120 herein are substantially cylindrical, the pins 120 may have other shapes, such as, for example, a cuboid, a triangular prism, a hexagonal prism, etc. The surface of the pins 120 may be smooth or slick to facilitate the movement of the pins 120 relative to the frame 130. The frame 130 has a plurality of apertures to allow the pins 120 to extend through the frame 130 (e.g., along the elongated axis of the pins 120). Depending on the embodiment, the frame 130 may be rigid or flexible. The stoppers 140 may secure the pins 120 within the frame 130 by preventing the pins 120 from sliding out. Also, a stopper 140 may also include a pin position detector that detects the position of the pin 120 relative to the frame 130, which may indicate how much the pin 120 can move relative to the frame 130 in either direction along the axis of the pin 120 that extends through the frame.

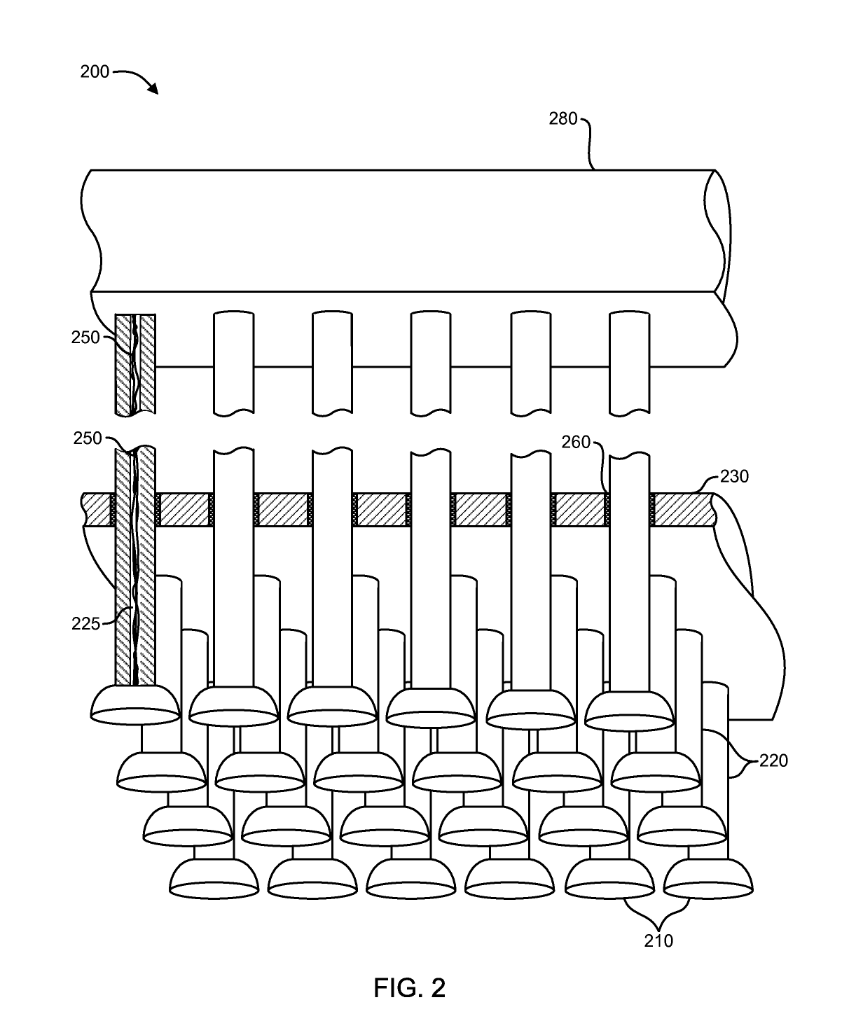

FIG. 2 illustrates an embodiment of part of a pinscreen sensing device 200. FIG. 2 shows a cutaway of the frame 230, a pin 220, and collars 260. The cutaway of the pin 220 shows a cavity 225 in approximately the center of the pin 220 that houses wires 250 that carry signals between the respective sensor 210 and other systems and devices. The collars 260 surround respective pins 220 and may support the pins 220, provide a barrier between the pins 220 and the frame 230, facilitate the movement of the pins 220, and/or restrict the movement of the pins 220. For example, the collars 260 may include one or more materials that permit movement of the pins 220 but that also provide a desired resistance (e.g., friction) to the movement, such as rubber, solid foam, etc. The collars 260 may also be lubricated to allow the pins 220 to move more freely. Additionally, the collars 260 may be adjustable between different positions and/or configurations to vary their resistance to the movement of the pins 220. For example, the collars 260 may include respective iris diaphragms, adjustable tightening members (e.g., screws), etc.

The pinscreen sensing device 200 also includes an actuator device 280. The actuator device 280 adjusts the positions of the pins 220 and may include position detectors for the respective pins 220 that indicate the positions of the pins 220 (the position detectors may also be located on the frame 230 and/or on the pins 220). The actuator device 280 may receive signals (e.g., from a computing system) that indicate positions for respective pins 220 and move the pins 220 into the indicated positions. Thus, the positions of the pins 220 may be saved and/or predetermined and sent to the actuator device 280, which moves the pins 220 to the respective positions.

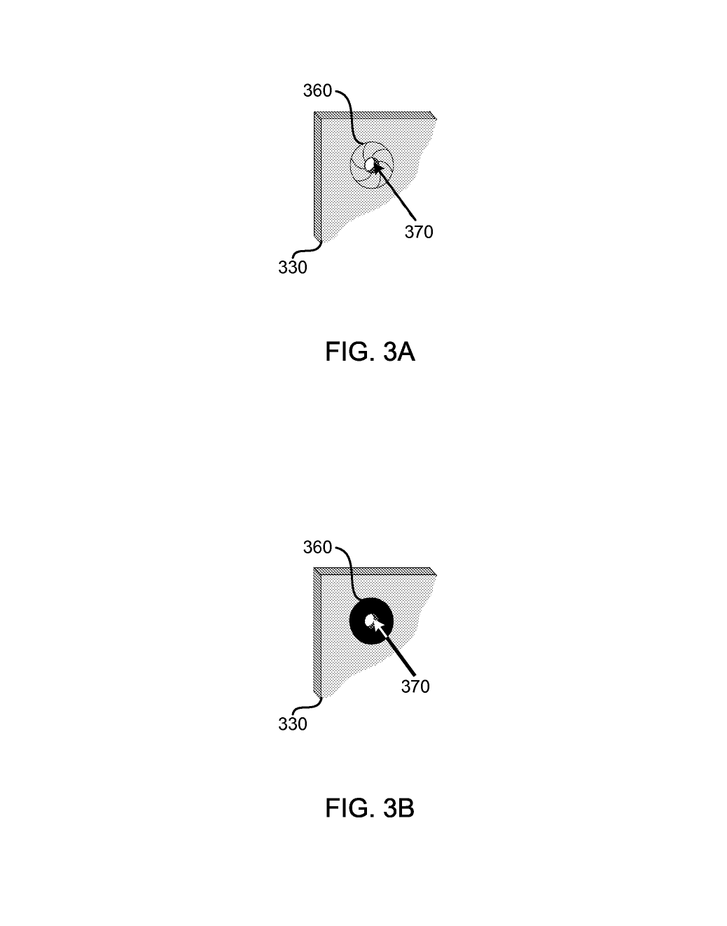

FIGS. 3A and 3B illustrate embodiments of a collar 360 and an aperture 370. In FIGS. 3A and 3B, the collar 360 defines an aperture 370 through the frame 330. In FIG. 3A, the collar 360 includes an iris diaphragm, which may be adjusted to vary the size of the aperture 370. The size of the aperture 370 may be changed to alter how easily a pin can move through the aperture 370. For example, the size of the aperture 370 may be decreased to increase resistance to movement of the pin, or the size of the aperture may be increased to allow the pin to move more easily. The collar 360 may include an actuator and be controlled by an electrical signal (e.g., a signal that indicates that the actuator should increase or decrease the size of the aperture 370).

In FIG. 3B, the collar 360 includes an annular opening that defines an aperture 370. The collar 360 may include materials such as elastomers, gels, foams, metal, and the collar 360 may be formed in various shapes, including an annular disc, torus, etc. The materials, shape, and size of the aperture 370 may be selected depending on various factors, including a desired resistance to movement of a pin through the aperture and desired support for a pin.

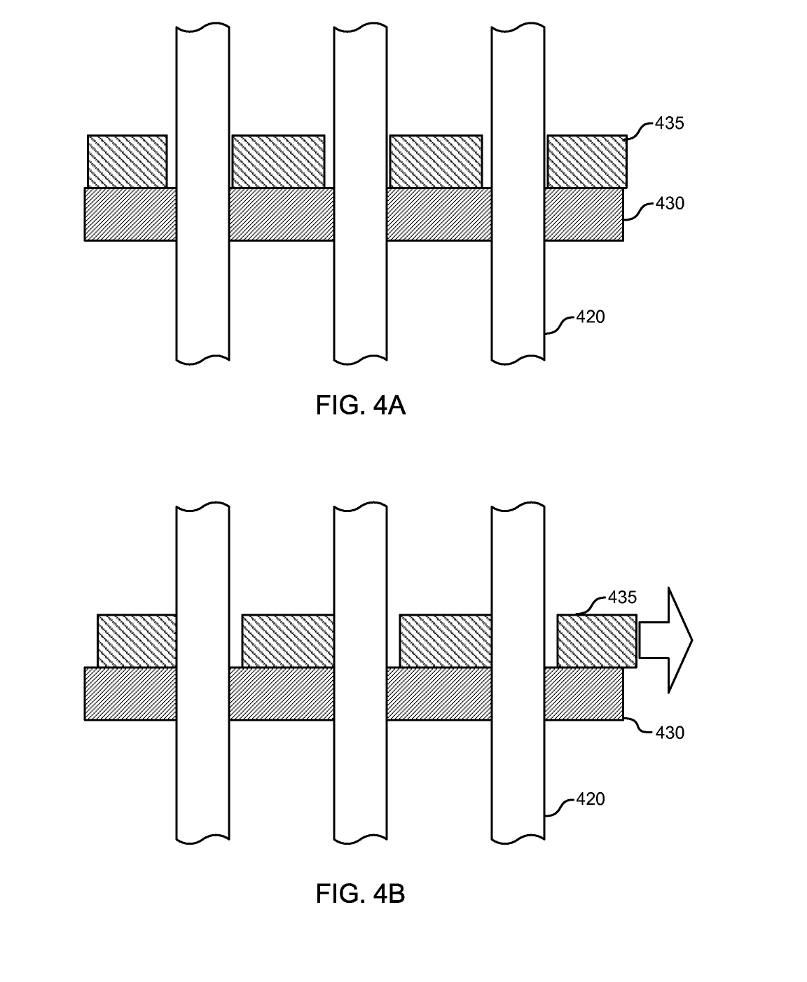

FIGS. 4A and 4B illustrate embodiments of a frame 430 for a pinscreen sensing device. The frame 430 includes one or more securing members 435, which may be in the shape of a grid or bars. The securing members 435 may be moved laterally relative to the frame 430 to exert a lateral force on the pins 420 in order to secure the pins 420 in respective desired positions. FIG. 4A illustrates a cutaway of the frame 430 and the securing members 435 in positions that do not contact the pins 420, and hence do not resist motion of the pins 420. FIG. 4B illustrates a cutaway of the frame 430 and the securing members 435 after the securing members 435 have been laterally moved to contact the pins 420 and resist motion of the pins 420.

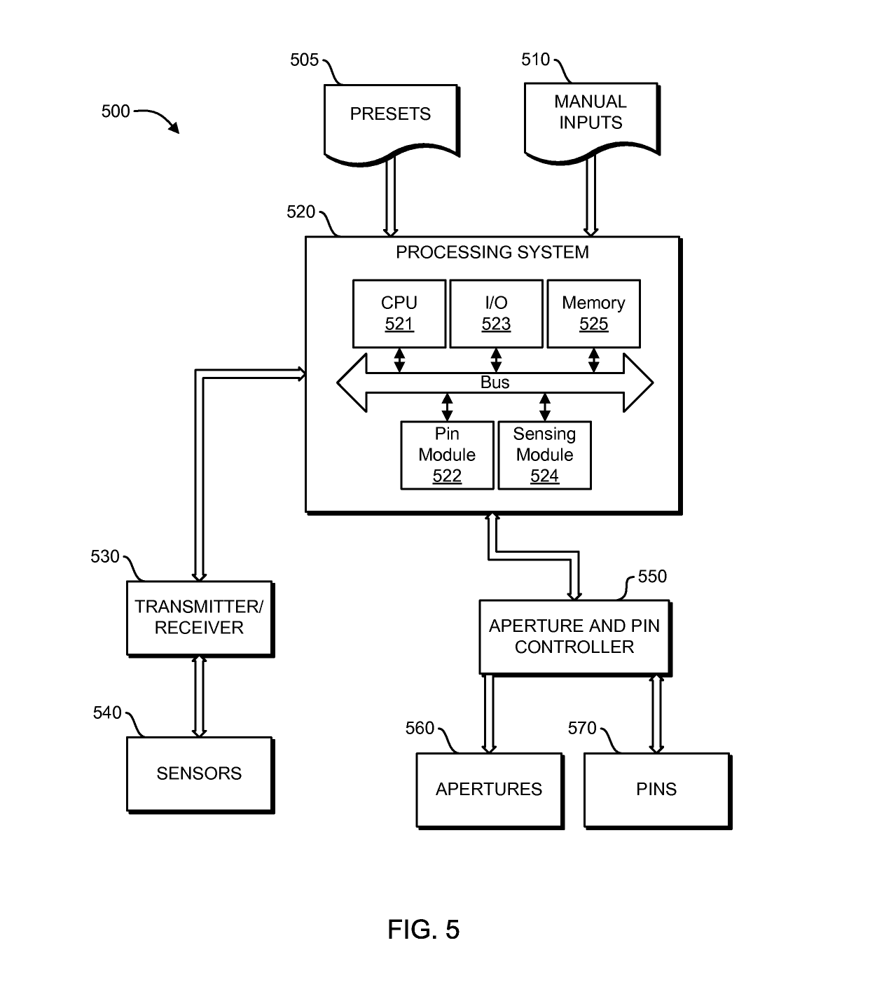

FIG. 5 is a block diagram that illustrates an embodiment of a sensing system 500. A processing system 520 receives one or more presets 505 and manual inputs 510 of settings for the system. The presets 505 and manual inputs 510 may indicate one or more of positions of the pins, as well as settings for a sensor 540 of the system (e.g., settings for ultrasound sensors, settings for electrical impedance tomography sensors). The processing system 520 sends signals to and receives signals from a transmitter/receiver 530 in order to initiate sensing by and receive sensed data from the sensors 540 and sends signals to and receives signals from an aperture and pin controller 550 in order to adjust the sizes of the apertures 560 and/or to adjust the positions of the pins 570.

The processing system 520 includes one or more processors 521 (also referred to herein as “CPU 521”), which may be conventional or customized central processing units (e.g., microprocessor(s)). The CPU 521 is configured to read and execute computer-executable instructions, and the CPU 521 may command/and or control other components of the processing system 520. The processing system 520 also includes I/O interfaces 523, which provide communication interfaces to input and output devices and other devices (e.g., computing devices), including a keyboard, a display, a mouse, a printing device, a touch screen, a light pen, an optical storage device, a scanner, a microphone, a camera, a drive, a network, etc., as well as the transmitter/receiver 530 and the aperture and pin controller 550. The I/O interfaces 523 may have wired and/or wireless capabilities, and the I/O interfaces 523 may receive the presets 505 and the manual inputs 510.

The processing system 520 additionally includes a memory 525, which includes one or more computer-readable and/or writable media, and may include, for example, a magnetic disk (e.g., a floppy disk, a hard disk), an optical disc (e.g., a CD, a DVD, a Blu-ray), a magneto-optical disk, a magnetic tape, semiconductor memory (e.g., a non-volatile memory card, flash memory, a solid state drive, SRAM, DRAM), an EPROM, an EEPROM, etc. The memory 525 may store computer-executable instructions and data. Note that the computer-executable instructions may include those for the performance of various methods described herein. The memory 525 is an example of a non-transitory computer-readable medium that stores computer-executable instructions thereon. The components of the processing system 520 are connected via a bus. Also, the processing system 520 includes an operating system, which manages one or more of the hardware, the processes, the interrupts, the memory, and the file system.

The processing system 520 also includes a pin module 522 and a sensing module 524. A module includes computer-executable instructions that may be executed by one or more members of the sensing system 500 to cause the sensing system 500 to perform certain operations, though for purposes of description a module may be described as performing the operations. Modules may be implemented in software (e.g., JAVA, C, C++, C#, Basic, Assembly), firmware, and/or hardware. In other embodiments, the processing system 520 may include more modules, less modules, and/or the modules may be divided into more modules. The instructions in the modules may be executed to perform the methods described herein. Modules may be implemented in any computer-readable storage medium that can be employed as a storage medium for supplying the computer-executable instructions. Furthermore, when the computer-executable instructions are executed, an operating system executing on the processing system 520 may perform at least part of the operations that implement the instructions.

The pin module 522 controls the configurations of the pins 570 and the apertures 560. The pin module 522 may receive current positions of the pins 570 and store a record of the positions (e.g., in the memory 525). Also, the pin module 522 may send signals to the aperture and pin controller 550 to move the pins 570 to certain positions and/or to change the sizes of the apertures 560 to further allow or resist movement of the pins 570.

For example, the apertures 560 may be configured to offer little or no resistance to movement of the pins 570 to allow the pins 570 to move to conform to the shape of an object, for example by bringing the object into contact with the sensors 540, which in turns moves the pins 570. The pin module 522 may receive a signal (e.g., from a user) that instructs the pin module 522 to store the current positions of the pins 570 in the memory 525 or the pin module 522 may store the current positions automatically, for example in response to initiation of sensing by the sensors 540. Also, the pin module 522 may generate a signal for the aperture and pin controller 550 that indicates that the aperture and pin controller 550 should reconfigure the apertures 560 to secure the pins 570 in place. Furthermore, the pin module 522 may retrieve and/or receive pin position data (e.g., the data previously saved, data received from a user, data calculated by a computing device) and instruct the aperture and pin controller 550 to reposition the pins 570 based on the pin position data. The aperture and pin controller 550 may then send signals to actuators to adjust the apertures 560 to allow movement of the pins 570, to move the pins into the indicated positions, and/or to adjust the apertures 560 to secure the pins 570 in their respective positions. Additionally, the pin module 522 may instruct the aperture and pin controller 550 to adjust the apertures 560 to increase or decrease resistance to movement of the pins 570 to allow for varying levels of resistance (e.g., nearly no resistance, slight resistance, moderate resistance, high resistance, max resistance) to permit a desired amount of pressure to move the pins 570, so the pins 570 do not move too easily but still move without requiring too much force.

The sensing module 524 controls the settings, activation, and deactivation of the sensors 540. Additionally, the sensing module 524 may receive data from the sensors 540 and perform operations on the data, for example combining the data, sorting the data, interpreting the data, and/or changing the data to a desired format. For example, the sensing module 524 may receive data from the sensors 540, combine the data, and generate an image from the data.

The aperture and pin controller 550 receives signals from the processing system 520, positions the pins 570, and/or adjusts the sizes of the apertures 560. The aperture and pin controller 550 may include one or more actuators that move the pins 570 and/or alter the sizes of the apertures 560.

The transmitter/receiver 530 receives signals (which may indicate commands, settings, etc.) from the processing system 520, transmits signals (which may include sensed data) to the processing system (as well as other signals that may also indicate commands, requests, settings, etc.), adjusts the configuration of the sensors, activates the sensors, and/or deactivates the sensors. The transmitter/receiver 530 may communicate with the processing system 520 via wired and/or wireless channels.

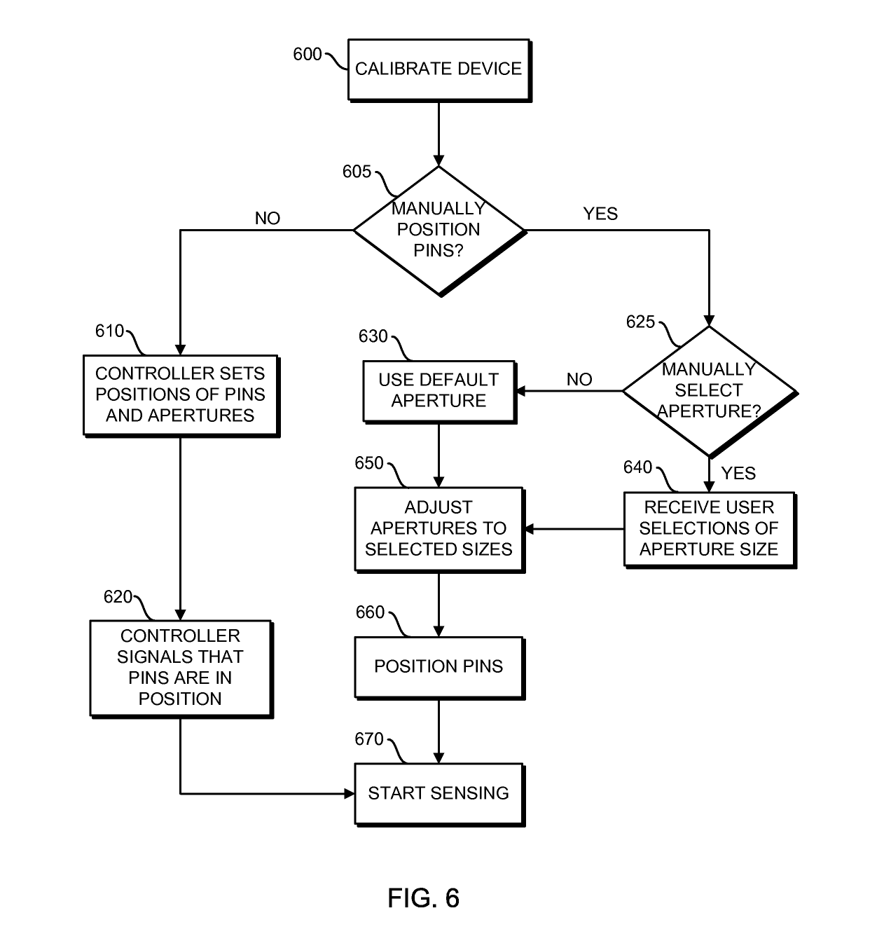

FIG. 6 is a block diagram that illustrates an embodiment of a method for sensing. Other embodiments of this method and the other methods described herein may omit blocks, add blocks, change the order of the blocks, combine blocks, and/or divide blocks into separate blocks. Additionally, one or more components of the systems and devices described herein may implement the method shown in FIG. 6 and the other methods described herein.

In block 600, a sensing device is calibrated (e.g., sensors, actuators, and/or position detectors are calibrated). Next, in block 605, it is determined if the pins are to be manually positioned. If it is determined that the pins are not to be manually positioned, then flow proceeds to block 610, where a controller sets the positions of the pins and apertures (e.g., opens the apertures, positions the pins, and/or closes the apertures). Then, in block 620, the controller signals that the pins are in position, and, in block 670, sensing is started.

However, if in block 605 it is determined that the pins are to be positioned manually, then flow proceeds to block 625, where it is determined if the sizes of the one or more apertures are to be manually selected. If the apertures are not to be manually selected, then in block 630 default apertures are selected. If the apertures are to be manually selected, then flow proceeds to block 640, where user selections of aperture sizes are received. In block 650 the apertures are adjusted to the selected sizes, and in block 660 the pins are positioned (e.g., by pressing the object to be sensed into the pins), and the apertures may be set to restrict further movement of the pins. Finally, in block 670, sensing is started.

The above described devices, systems, and methods can be achieved by supplying one or more storage media having stored thereon computer-executable instructions for realizing the above described operations to one or more devices that are configured to read the computer-executable instructions stored in the one or more storage media and execute them. In this case, the systems and/or devices perform the operations of the above-described embodiments when executing the computer-executable instructions read from the one or more storage media. Also, an operating system on the one or more systems and/or devices may implement at least some of the operations of the above described embodiments. Thus, the computer-executable instructions and/or the one or more storage media storing the computer-executable instructions therein constitute an embodiment.

Any applicable computer-readable storage medium (e.g., a magnetic disk (including a floppy disk and a hard disk), an optical disc (including a CD, a DVD, a Blu-ray disc), a magneto-optical disk, a magnetic tape, and a solid state drive (including flash memory, DRAM, SRAM) can be employed as a storage medium for the computer-executable instructions. The computer-executable instructions may be written to a computer-readable storage medium provided on a function-extension board inserted into the device or on a function-extension unit connected to the device, and a CPU provided on the function-extension board or unit may implement the operations of the above-described embodiments.

While the above disclosure describes illustrative embodiments, it is to be understood that the invention is not limited to the above disclosure. To the contrary, the invention covers various modifications and equivalent arrangements within the spirit and scope of the appended claims.

What is claimed is:

1. A device for sensing, the device comprising:
a frame;
a plurality of independently positionable members coupled to the frame, wherein a respective independently positionable member is elongated along a first axis and is positionable relative to the frame; and
a plurality of sensors, wherein a sensor is coupled to a respective independently positionable member.

2. The device of claim 1, further comprising a securing member positionable in at least a first position and a second position, wherein in the first position the securing member exerts greater resistance to movement of one or more of the plurality of independently positionable members relative to the frame and wherein in the second position the securing member less resistance to movement of the one or more of the independently positionable members relative to the frame.

3. The device of claim 2, wherein the securing member defines an adjustable aperture.

4. The device of claim 1 wherein the independently positionable members are elongated along a first axis and are positionable along the first axis.

5. The device of claim 1, wherein the plurality of sensors defines a first surface, and wherein a shape of the first surface can be adjusted by repositioning one or more of the plurality of independently positionable members.

6. The device of claim 1, further comprising a computing device coupled to the plurality of sensors.

7. The device of claim 1, wherein the sensors are configured to generate signals and detect signals.

8. The device of claim 7, wherein the signals include one or more of ultrasound signals and optical coherence tomography signals.

9. A device for sensing one or more signals, the device comprising:
a plurality of pins, wherein the pins are independently movable relative to one another;
one or more signal generators coupled to respective pins;
one or more signal detectors coupled to respective pins; and
a body, wherein the plurality of pins are coupled to the body.

10. The device of claim 9, wherein the pins in the plurality of pins are substantially parallel to one another along a first axis.

11. The device of claim 10, wherein the pins are independently movable along the first axis.

12. The device of claim 9, wherein the one or more signal generators and the one or more signal detectors define a changeable surface, wherein the surface changes as one or more of the pins is moved.

13. The device of claim 9, further comprising one or more collars surrounding respective pins, wherein the one or more collars resist movement of the respective pins.

14. The device of claim 9, further comprising a locking member, wherein the locking member may be selectively engaged to increase resistance to movement of at least one pin and wherein the locking member may be selectively disengaged so as to decrease resistance to movement of the at least one pin.

15. The device of claim 9, further comprising one or more position detectors configured to detect respective positions of one or more pins and generate signals indicating the detected positions.

16. A device for imaging, the device comprising:
a plurality of sensors configured to detect signals; and
means for mounting the plurality of sensors such that the plurality of sensors are independently movable.

17. The device of claim 16, further comprising means for selectively securing the means for mounting.
